(19) United States
(12) Patent Application Publication
(10) Pub. No.: US 2013/0204905 A1
(43) Pub. Date: Aug. 8, 2013

(54) REMAPPING LOCALITY-SENSITIVE HASH VECTORS TO COMPACT BIT VECTORS

(71) Applicant: Sergey Ioffe, Mountain View, CA (US)

(72) Inventor: Sergey Ioffe, Mountain View, CA (US)

(73) Assignee: GOOGLE INC., Mountain View, CA (US)

(21) Appl. No.: 13/368,193

(22) Filed: Feb. 7, 2012

(51) Int. Cl. G06F 17/30

(52) U.S. Cl. 707/803; 707/E17.044

(57) ABSTRACT

Methods, systems, and apparatus, including computer programs encoded on a computer storage medium, for receiving a hash vector r, a vector of locality-sensitive hash values, each hash value being an element of the hash vector r, each element having an index position; and generating a compact vector v corresponding to the hash vector r, wherein the compact vector v is a vector of compact elements each having an index position, wherein each compact element corresponds to the element of the hash vector r having the same index position, and wherein each compact element is a b-bit integer selected from the set of all b-bit integers {0, 1, . . . , 2^{b}−1} based on the corresponding hash element.

### BACKGROUND

This specification relates to remapping locality-sensitive hash vectors to bit vectors.

A feature vector is an ordered set of values representing respective features of an entity. An entity's feature vector can be stored and used as a fingerprint that describes or characterizes the entity. For example, in nearest-neighbor computations, a degree of similarity between entities can be determined based on measuring the distances between their respective feature vectors in feature space.

A variety of well-known dimensionality reduction techniques have been developed to encode high-dimensional feature vectors into lower-dimensional, more compact representations. These lower-dimensional representations can approximate the distance relationships of the raw feature vectors, and thus they can be used instead of the feature vectors in similarity computations.

Locality-sensitive hashing is a dimensionality reduction technique for encoding high-dimensional vectors into more compact hash vector representations. Each hash vector element is a hash computed by applying a locality-sensitive hash function to the feature vector. The dimensionality of each hash vector representation is determined by the number of applications of one or more hash functions to the feature vector. In some implementations, the hash elements can be represented using fewer bits than their corresponding feature vector element values.

Compression is often combined with dimensionality-reduction to compact the lower-dimensional vector representations further. Compression of a hash vector modifies the hash element values, which results in distortion of the distances between the hash vectors. Thus, hash vectors that have been compressed must be uncompressed before they can be used in similarity computations.

### SUMMARY

An entity's feature vector can be stored and used as a fingerprint that describes or characterizes the entity. Image, audio, video, and text entities are examples of entities that often are represented by high-dimensional feature vectors (i.e., feature vectors that contain many elements). Storing a high-dimensional feature vector can require a large amount of storage space, e.g., one image feature vector can require 0.5 Mb of storage, and thus the storage requirements for a repository of high-dimensional feature vectors may exceed available system storage resources.

Locality-sensitive hashing is one type of dimensionality reduction technique used to encode high-dimensional feature vectors into lower-dimensional, more compact vector representations. An n-dimensional feature vector is encoded into a corresponding m-dimensional hash vector of hash elements, where m<n. Distance relationships of these lower-dimensional representations can approximate the distance relationships of the original feature vectors, and thus they can be used instead of the feature vectors in similarity computations.

Hash vector representations are further compacted into bit vectors by remapping the hash element values to b-bit integer values, where b>0 and the value of b is less than the size of a hash vector element in bits. If there are statistical relationships between the hash collisions and distances between points in the hash vectors, these statistical relationships will be retained in the bit vectors after the remapping. Thus, the compact bit vectors can be used instead of the hash vector representations in similarity computations.

In general, one innovative aspect of the subject matter described in this specification can be embodied in methods that include the actions of receiving a hash vector r, a vector of locality-sensitive hash values, each hash value being an element of the hash vector r, each element having an index position; and generating a compact vector v corresponding to the hash vector r, wherein the compact vector v is a vector of compact elements each having an index position, wherein each compact element corresponds to the element of the hash vector r having the same index position, and wherein each compact element is a b-bit integer selected from the set of all b-bit integers {0, 1, . . . , 2^{b}−1} based on the corresponding hash element.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. The hash vector r represents a feature vector that represents an entity, and the method further includes storing the compact vector v as a representation of the entity. Each b-bit integer is uniformly selected from {0, 1, . . . , 2^{b}−1} based on the corresponding hash element and the index position of the hash element in the hash vector r. Selecting the b-bit integer from the set of all b-bit integers includes using a pseudorandom number generator that is initialized using the corresponding hash element as a seed.

Selecting the b-bit integer from the set of all b-bit integers includes using a pseudorandom number generator that is initialized using the corresponding hash element and the index position of the corresponding hash element in hash vector r as a seed. Generating the compact vector v includes assigning each of the hash elements of hash vector r to one of 2^{b} groups, where each group has a unique b-bit integer identifier; and for each compact element of the compact vector v, identifying the group to which the corresponding hash element is assigned; and assigning the b-bit identifier of the group to the index position of the compact element.

In general, one innovative aspect of the subject matter described in this specification can be embodied in methods that include the actions of maintaining a data store of entity representations of a plurality of entities, each stored entity representation including a compact vector of N compact elements, wherein each compact element corresponds to an element of a hash vector of N hash elements generated using locality-sensitive hashing from a feature vector representing an entity, and wherein each compact element is a b-bit integer selected from the set of all b-bit integers {0, 1, . . . , 2^{b}−1} based on the corresponding hash element; receiving a query including data representing a particular entity, the data including a compact vector v of N compact elements, wherein each compact element corresponds to an element of a hash vector of N hash elements generated using the locality-sensitive hashing from a feature vector representing the particular entity, and wherein each compact element is a b-bit integer selected from {0, 1, . . . , 2^{b}−1} based on the corresponding hash element; and responsive to the query, calculating a similarity measure between the particular entity and each of the plurality of entities by comparing the compact vector v and the compact vector included in the respective stored entity representation of the entity.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. The method further includes determining that an entity is similar to the particular entity if the similarity measure between the particular entity and the entity satisfies a similarity threshold. The method further includes: after calculating the similarity measure between the particular entity and each of the plurality of entities, determining a maximum similarity measure from the calculated similarity measures; and identifying one or more nearest neighbor entities from the plurality of entities, wherein a similarity measure between a nearest neighbor entity and the particular entity is determined to be within a threshold range of the maximum similarity measure.

Comparing the compact vector v and a compact vector from a stored entity representation includes: computing the Hamming distance between the vectors by determining the number of corresponding b-bit groups between the vectors that have different values. The locality-sensitive hashing is a MinHash. The method further includes using the Hamming similarity between the compact vector v and the compact vector from a stored entity representation to approximate the Jaccard similarity between the feature vector representing the particular entity and the feature vector representing the entity represented by the stored entity representation. The method further includes choosing an optimal value of b based in part on satisfying a memory budget.

Particular embodiments of the subject matter described in this specification can be implemented so as to realize one or more of the following advantages.

Remapping hash vectors into compact bit vectors applies to any underlying hashing scheme. The bit vectors maintain the distance relationships in Hamming space of the original hash vectors. Thus, the bit vectors can be used in similarity computations instead of the hash vectors. Bit vectors do not require extra processing, e.g., uncompressing compressed vectors, prior to their being used in similarity computations. Computations that use more the more compact bit vector representations enable more efficient use of available computing resources, e.g., memory, than computations using the hash vectors or the original feature vectors.

The reduced storage requirements of compact vectors of b-bit integers maximize the number of entity representations that can be stored within the bounds set by fixed memory constraints. An optimal value of b can be determined based on characteristics of a particular task for which the bit vector representations will be used. For example, an optimal value of b can be chosen by resolving a task-specific tradeoff between providing the most accurate distance approximation after remapping and the constraints of a fixed memory budget B in bits.

Although new collisions will generally be introduced as a result of the remapping, it is unlikely that these spurious new collisions would be consistent enough to affect the vector distance estimates significantly. The value of b can be chosen according to a policy that will minimize the number of extra collisions introduced by the remapping.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A and 1B illustrate an example process for generating compact bit vector representations of high-dimensional feature vectors.

FIG. 2 is a flow diagram of an example method for generating a compact bit vector representation of a hash vector.

FIG. 3 is a flow diagram of an example method for remapping a hash element to a b-bit value.

FIG. 4 is a flow diagram of an example method for identifying entities similar to a particular entity based on comparing their respective compact bit vector representations.

### DETAILED DESCRIPTION

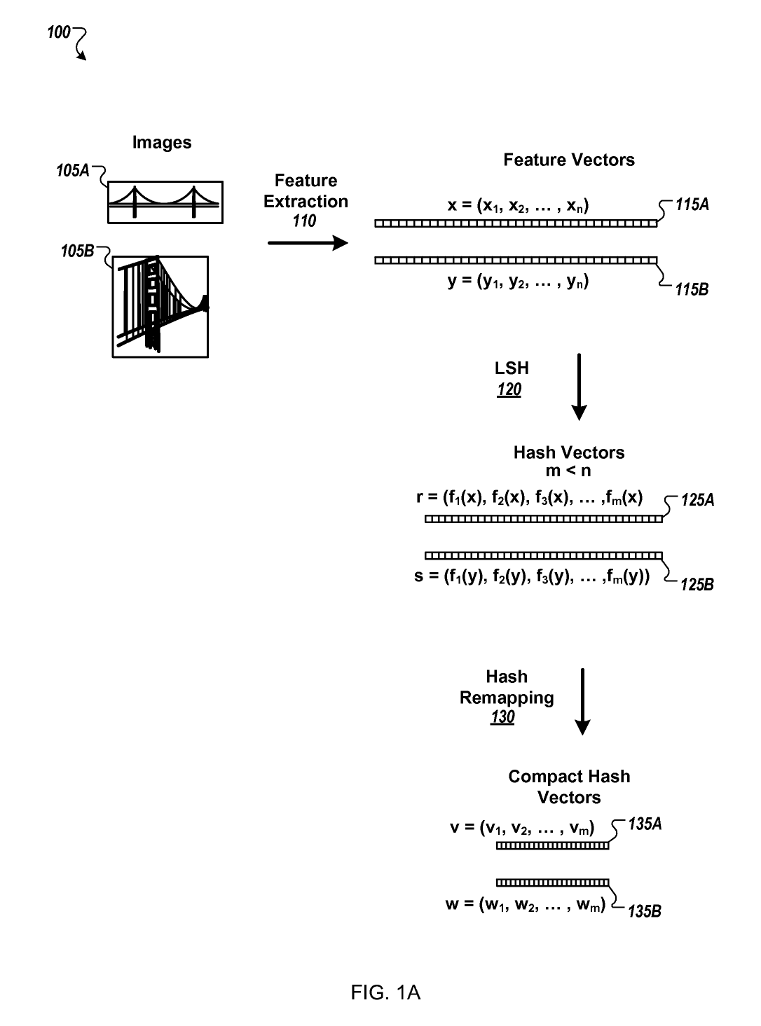

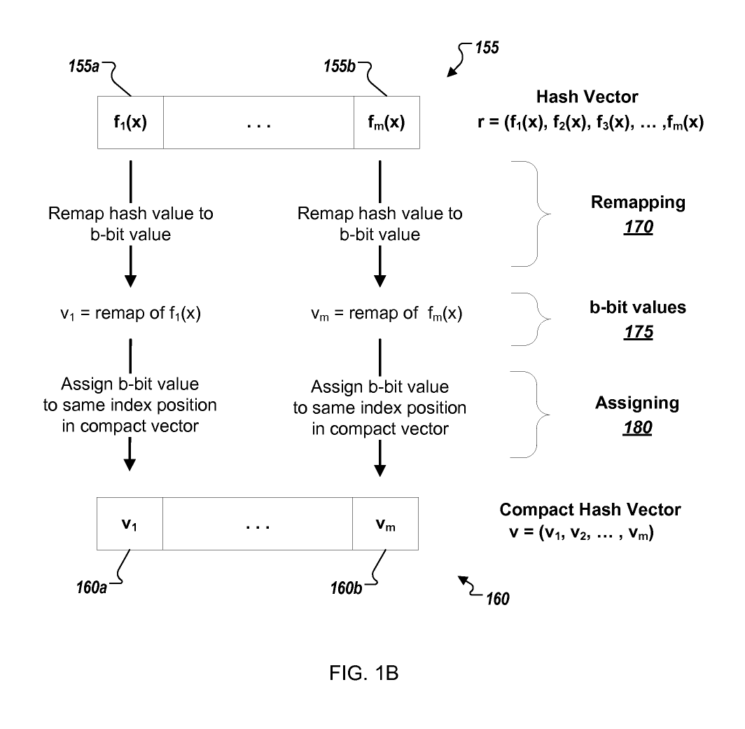

FIGS. 1A and 1B illustrate an example process 100 for generating compact bit vector representations of high-dimensional feature vectors. The bit vector representations can be used directly to compute a degree of similarity among the entities respectively represented by the feature vectors.

During feature extraction 110, raw data describing each of the input image entities 105A, 105B is encoded into respective n-dimensional feature vectors x 115A and y 115B. Locality-sensitive hashing (LSH) 120 is used to encode the feature vectors x 115A and y 115B respectively into more compact m-dimensional hash vector representations r 125A and s 125B, where m<n. In some cases, lower-dimensional hash vector encodings of feature vectors are called sketches.

One well-known type of LSH scheme is MinHash. Consider, for purposes of illustration, that the m-dimensional hash vectors r 125A and s 125B were generated from n-dimensional feature vectors x 115A and y 115B using a MinHash technique. A sequence of m hash functions f₁, f₂, f₃, . . . , fₘ is created by randomly selecting the m hash functions from a pool of locality-sensitive hash functions. A sequence of m permutations P₁, P₂, P₃, . . . , Pₘ is generated, where each permutation is a particular re-ordering of the element positions in a feature vector. A feature vector x with elements re-ordered according to a particular permutation p can be represented as xPₚ.

Under the MinHash example, each generated hash vector will be an m-dimensional vector with each hash element computed by applying the hash function at the corresponding index position in the sequence of m hash functions to the feature vector after its elements have been re-ordered according to the permutation at the corresponding position in the sequence of m permutations. Thus, with respect to process 100, the hash vector r 125A representation of feature vector x 115A computed using the MinHash example would be f₁(xP₁), f₂(xP₂), f₃(xP₃), fₘ(x Pₘ) and the hash vector s 125B representation of feature vector y 115B would be f₁(yP₁), f₂(yP₂), f₃(y P₃), . . . , fₘ(y Pₘ).

The distances between sketches in the Hamming hash space approximate the distances between their corresponding feature vectors in the feature space, i.e., similar features map to similar hashes. A characteristic of MinHash hash vectors is that, for two vectors X and Y, the probability that their encoded hash vectors are equal, i.e., MinHash(X)=MinHash(Y), is the same as J(X, Y), which is the Jaccard similarity between the original feature vectors. The Jaccard similarity between two vectors is a similarity coefficient representing the number of their shared similar elements, where

$$J ( X , Y ) = \frac{\vert X ⋂ Y \vert}{\vert X ⋃ Y \vert} \qquad ( 1 )$$

The probability of hash collision between corresponding elements of MinHash(X) and MinHash(Y), when sampling the hash elements randomly, is approximated by 1−J(X, Y), the Jaccard distance between original feature vectors X and Y. This means that, as the number of hashes, i.e., dimensionality, represented in the hash vectors becomes large, J(X, Y) can be approximated in terms of the Hamming distance L0 between the hashes of X, denoted as h_X, and the hashes of Y, denoted as h_Y, according to the equation:

J(X,Y)≈1−L0(h_X,h_Y) (2)

As illustrated in FIG. 1A, the sketch hash vectors r 125A and s 125B are further compacted 130 into respective compacted bit vectors v 135A and w 135B.

As illustrated in FIG. 1B, in some implementations, a compacted bit vector 160 is generated by remapping 170 each hash vector element 155a . . . 155b in the corresponding hash vector 155 to a b-bit integer value 175, where b>0 and the value of b is less than the size of the hash in bits, and then assigning 180 the b-bit value to the bit vector element 160a . . . 160b at the index position in the bit vector 160 that corresponds to the index position of the hash element in the hash vector 155. If there are statistical relationships between the hash collisions and distances between points in the hash vector 155, these statistical relationships will be retained in the bit vector 160 after the remapping.

In some implementations, each hash element is randomly mapped to a b-bit value. If two hash elements are the same, they will be mapped to the same b-bit value after random remapping. If the two hash elements are different, their randomly remapped b-bit values will collide with a probability of 2^{-b}. In general, if the hash collision probability is P before random b-bit remapping, it becomes P+(1−P)/2^{b}=2^{-b} after remapping.

Although new collisions will be introduced as a result of the remapping, it is unlikely that these spurious new collisions would be consistent enough to affect the vector distance estimates significantly. Consider the MinHash example for illustration. As previously described with respect to the example, the probability of hash collision between corresponding hashes of two vectors generated using MinHash can be expressed in terms of the Jaccard distance 1−J between the original feature vectors. Therefore, the probability of collision Pr between corresponding hash elements in two MinHash hash vectors after randomly remapping them into b-bit values also can be approximated in terms of the Jaccard similarity J^{(b)} between the vectors:

Pr=J+(1−J)×2^{-b}=J^{(b)} (3)

As was described with reference to FIGS. 1A and 1B, the number of extra collisions produced after randomly remapping hashes to b-bit integer values generally increases as the value of b increases, and an optimal choice for the value of b trades off between the number of hash elements H represented in the hash vectors and the vectors' accuracy after remapping.

In some implementations, an optimal value of b is determined empirically. In some alternative implementations, an optimal value of b is chosen based on evaluating the choice of b in terms of a memory budget of B bits. For example, for each considered value of b, e.g., values ranging from 1 to 8, a resulting set of B/b hashes are evaluated using an evaluation function. In some implementations, the evaluation function used is determined by characteristics of a computation task applied to the vectors. The optimal value of b is the considered value of b for which the evaluation function value is maximized.

In some implementations, an optimal choice of the value of b is made that trades off between the dimensionality of the hash vectors, i.e., the number of hash elements per vector H, and the accuracy of the distance between vectors after remapping. As seen in Equation (2), the Hamming distance between the hashes of two MinHash vectors can be approximated by the Jaccard distance between the feature vectors. Thus, the Hamming similarity of H b-bit hashes, denoted as HashSim_{H}^{(b)}, can be approximated according to the equation:

$$J = \frac{{J}^{( b )} - {2}^{- b}}{1 - {2}^{b}} \approx \frac{{HashSim}_{H}^{( b )} - {2}^{- b}}{1 - {2}^{- b}} \qquad ( 4 )$$

If the relationship between J and the distance d between two hash vectors is locally approximated to be linear, the variance of the distance estimate \hat{d}^{(b)} between their remapped b-bit representations can be computed in terms of H and b according to the equation:

$$Var [ {\hat{d}}^{( b )} ] = \frac{{J}^{( b )} ( 1 - {J}^{( b )} )}{H} \times {( \frac{\partial {J}^{( b )}}{\partial d} )}^{- 2} \qquad ( 5 )$$

In some implementations, the m-dimensional bit vector representation v 135A is generated by remapping each of the hash elements of r 125A to a respective b-bit integer value according to a policy that will minimize the extra collisions produced as a result of the remapping. For example, in some implementations, each hash is assigned to one of 2^{b} groups, and is mapped to the b-bit key identifier of the group to which it is assigned. In some implementations, the 2^{b} groups are created by a greedy selection process, as, for example, starting with each hash in its own group and then iteratively merging the two least-common groups (i.e., the two groups containing hashes determined to have the lowest mutual information) until 2^{b} groups remain.

One appropriate type of MinHash, Weighted MinHash, is described, for example, in S. Ioffe, “Improved Consistent Sampling, Weighted MinHash, and L1 Sketching Under Jaccard and L1 Metrics,” The 10th IEEE International Conference on Data Mining, 2010. Under an example using Weighted MinHash, which is based on Jaccard and L1 norm distance metrics, if B is the total number of bits in the memory budget, H=B/b, and thus the variance of the distance estimate between the vectors (see Equation 5) can be evaluated for various values of b for pairs of vectors having similar distances and sums of norms N according to the equation:

$$Var [ {\hat{d}}^{( b )} ] = \frac{{d ( N + d )}^{2} ( N - d ( 1 - {2}^{1 - b} ) ) b}{2 {N}^{2} ( 1 - {2}^{- b} ) B} \qquad ( 6 )$$

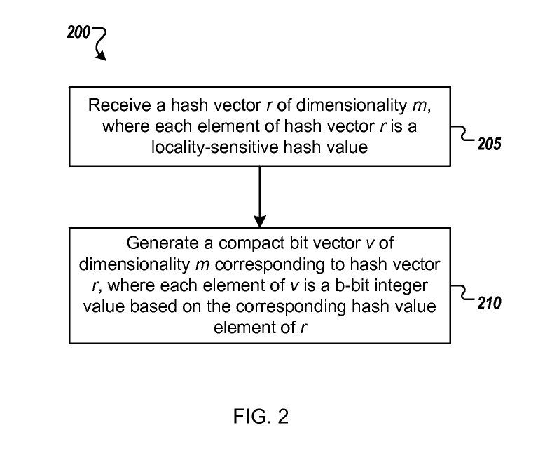

FIG. 2 is a flow diagram of an example method 200 for generating a compact bit vector representation of a hash vector. For convenience, the method 200 will be described with respect to a system that includes one or more computers and performs the method 200. In some implementations, the method 200 is performed to generate a compact representation of a sketch, as described above with respect to FIG. 1.

After receiving 205 a hash vector r 125A of dimensionality m, the system generates 210 an m-dimensional bit vector representation v 135A of hash vector r 125A by remapping each hash element of r 125A to a b-bit integer value (where the value of b is greater than zero and less than the size of the hash element in bits), and then assigning that b-bit integer value to an index position in v corresponding to the hash value index position in r 125A.

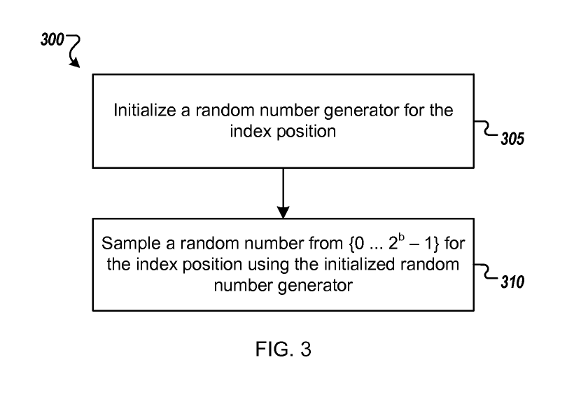

FIG. 3 is a flow diagram of an example method 300 for remapping a hash element to a b-bit value. For convenience, the method 300 will be described with respect to a system that includes one or more computers and performs the method 300. In some implementations, the method 300 is performed to remap 170 a hash element to a b-bit value, as described above with reference to FIGS. 1A and 1B. The method 300 is performed for the hash element at each index position of the hash vector.

A random number generator for an index position, e.g., a pseudorandom number generator, is initialized 305 for the index position. The random number generator is initialized based on the hash value at the index position and, optionally, the index position.

The system then uses the initialized pseudorandom number generator for the index position to sample 310 a b-bit integer uniformly from the set of b-bit integers {0 . . . 2^{b}−1}. The sampled value is then used as the value of the bit vector at the index position.

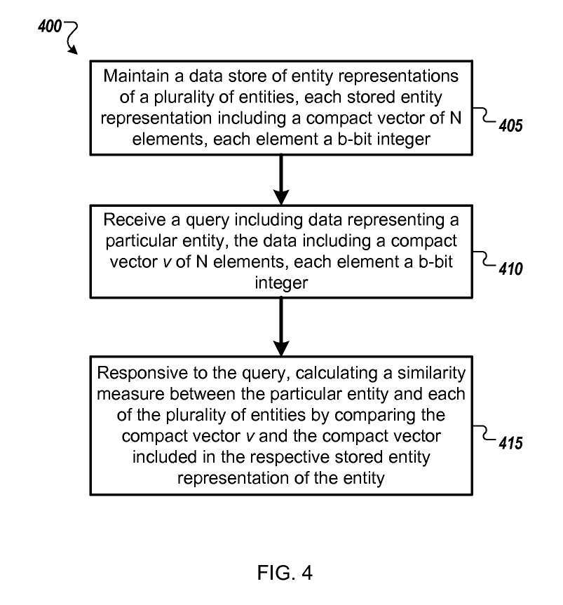

FIG. 4 is a flow diagram of an example method 400 for identifying entities similar to a particular entity based on comparing their respective compact bit vector representations. For convenience, the method 400 will be described with respect to a system that includes one or more computing devices and performs the method 400.

The system maintains 405 a data store of entity representations of a plurality of entities. Each entity representation includes an m-dimensional compact bit vector representation, where each compact element is a b-bit integer value. In some implementations, each of the compact bit vectors is generated using method 200. In some implementations, each of the compact bit vectors is a representation of an m-dimensional hash vector, where b>0 and the value of b is less than the size of a hash vector element in bits. Each m-dimensional hash vector is a representation of an n-dimensional feature vector representing a respective entity, m<n, as described above with reference to FIGS. 1A and 1B. In some implementations, each hash vector is generated from the corresponding feature vector using a locality-sensitive hashing method.

The system receives 410 a query including data representing a particular entity. The data include an m-dimensional compact vector v of b-bit integer elements. Compact vector v was generated from an m-dimensional hash vector and an n-dimensional feature vector using the same methods used to generate the compact vectors included in the stored entity representations maintained by the system.

Responsive to the query, the system identifies 415 one or more of the plurality of entities that are similar to the particular entity based on comparing the compact vector v to the compact vectors respectively included in each of the stored entity representations. In some implementations, the particular entity is determined to be similar to one of the plurality of entities if the distance in Hamming space between their respective compact vector representations is determined to be less than a distance threshold, as described with reference to FIG. 1A. In some implementations, the distance between two compact vectors is represented as an intersection kernel between the vectors that is computed using Principal Component Analysis (PCA).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, (e.g., a machine-generated electrical, optical, or electromagnetic signal) that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-transitory memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
receiving a hash vector r, a vector of locality-sensitive hash values, each hash value being an element of the hash vector r, each element having an index position; and
generating a compact vector v corresponding to the hash vector r, wherein the compact vector v is a vector of compact elements each having an index position, wherein each compact element corresponds to the element of the hash vector r having the same index position, and wherein each compact element is a b-bit integer selected from the set of all b-bit integers {0, 1, . . . , 2^{b}−1} based on the corresponding hash element.

2. The method of claim 1, wherein the hash vector r represents a feature vector that represents an entity, the method further comprising:
storing the compact vector v as a representation of the entity.

3. The method of claim 1, wherein each b-bit integer is uniformly selected from {0, 1, . . . , 2^{b}−1} based on the corresponding hash element and the index position of the hash element in the hash vector r.

4. The method of claim 1, wherein selecting the b-bit integer from the set of all b-bit integers comprises:
using a pseudorandom number generator that is initialized using the corresponding hash element as a seed.

5. The method of claim 1, wherein selecting the b-bit integer from the set of all b-bit integers comprises:
using a pseudorandom number generator that is initialized using the corresponding hash element and the index position of the corresponding hash element in hash vector r as a seed.

6. The method of claim 1, wherein generating the compact vector v comprises:
assigning each of the hash elements of hash vector r to one of 2^{b} groups, where each group has a unique b-bit integer identifier; and
for each compact element of the compact vector v,
identifying the group to which the corresponding hash element is assigned; and
assigning the b-bit identifier of the group to the index position of the compact element.

7. A method, comprising:
maintaining a data store of entity representations of a plurality of entities, each stored entity representation including a compact vector of N compact elements, wherein each compact element corresponds to an element of a hash vector of N hash elements generated using locality-sensitive hashing from a feature vector representing an entity, and wherein each compact element is a b-bit integer selected from the set of all b-bit integers {0, 1, . . . , 2^{b}−1} based on the corresponding hash element;
receiving a query including data representing a particular entity, the data including a compact vector v of N compact elements, wherein each compact element corresponds to an element of a hash vector of N hash elements generated using the locality-sensitive hashing from a feature vector representing the particular entity, and wherein each compact element is a b-bit integer selected from {0, 1, . . . , 2^{b}−1} based on the corresponding hash element; and
responsive to the query,
calculating a similarity measure between the particular entity and each of the plurality of entities by comparing the compact vector v and the compact vector included in the respective stored entity representation of the entity.

8. The method of claim 7, further comprising:
determining that an entity is similar to the particular entity if the similarity measure between the particular entity and the entity satisfies a similarity threshold.

9. The method of claim 7, further comprising:
after calculating the similarity measure between the particular entity and each of the plurality of entities,
determining a maximum similarity measure from the calculated similarity measures; and
identifying one or more nearest neighbor entities from the plurality of entities, wherein a similarity measure between a nearest neighbor entity and the particular entity is determined to be within a threshold range of the maximum similarity measure.

10. The method of claim 7, wherein comparing the compact vector v and a compact vector from a stored entity representation comprises:
computing the Hamming distance between the vectors by determining the number of corresponding b-bit groups between the vectors that have different values.

11. The method of claim 7, wherein the locality-sensitive hashing is a MinHash.

12. The method of claim 11, further comprising:
using the Hamming similarity between the compact vector v and the compact vector from a stored entity representation to approximate the Jaccard similarity between the feature vector representing the particular entity and the feature vector representing the entity represented by the stored entity representation.

13. The method of claim 7, further comprising:
choosing an optimal value of b based in part on satisfying a memory budget.

14. A computer storage medium encoded with instructions that when executed by one or more computers cause the one or more computers to perform operations comprising:
receiving a hash vector r, a vector of locality-sensitive hash values, each hash value being an element of the hash vector r, each element having an index position; and
generating a compact vector v corresponding to the hash vector r, wherein the compact vector v is a vector of compact elements each having an index position, wherein each compact element corresponds to the element of the hash vector r having the same index position, and wherein each compact element is a b-bit integer selected from the set of all b-bit integers {0, 1, . . . , 2^{b}−1} based on the corresponding hash element.

15. The storage medium of claim 14, wherein the hash vector r represents a feature vector that represents an entity, the storage medium further comprising:
storing the compact vector v as a representation of the entity.

16. The storage medium of claim 14, wherein each b-bit integer is uniformly selected from {0, 1, . . . , 2^{b}−1} based on the corresponding hash element and the index position of the hash element in the hash vector r.

17. The storage medium of claim 14, wherein selecting the b-bit integer from the set of all b-bit integers comprises:
using a pseudorandom number generator that is initialized using the corresponding hash element as a seed.

18. The storage medium of claim 14, wherein selecting the b-bit integer from the set of all b-bit integers comprises:
using a pseudorandom number generator that is initialized using the corresponding hash element and the index position of the corresponding hash element in hash vector r as a seed.

19. The storage medium of claim 14, wherein generating the compact vector v comprises:
assigning each of the hash elements of hash vector r to one of 2^{b} groups, where each group has a unique b-bit integer identifier; and
for each compact element of the compact vector v,
identifying the group to which the corresponding hash element is assigned; and
assigning the b-bit identifier of the group to the index position of the compact element.

20. A computer storage medium encoded with instructions that when executed by one or more computers cause the one or more computers to perform operations comprising:
maintaining a data store of entity representations of a plurality of entities, each stored entity representation including a compact vector of N compact elements, wherein each compact element corresponds to an element of a hash vector of N hash elements generated using locality-sensitive hashing from a feature vector representing an entity, and wherein each compact element is a b-bit integer selected from the set of all b-bit integers {0, 1, . . . , 2^{b}−1} based on the corresponding hash element;
receiving a query including data representing a particular entity, the data including a compact vector v of N compact elements, wherein each compact element corresponds to an element of a hash vector of N hash elements generated using the locality-sensitive hashing from a feature vector representing the particular entity, and wherein each compact element is a b-bit integer selected from {0, 1, . . . , 2^{b}−1} based on the corresponding hash element; and
responsive to the query,
calculating a similarity measure between the particular entity and each of the plurality of entities by comparing the compact vector v and the compact vector included in the respective stored entity representation of the entity.

21. The storage medium of claim 20, further comprising:
determining that an entity is similar to the particular entity if the similarity measure between the particular entity and the entity satisfies a similarity threshold.

22. The storage medium of claim 20, further comprising:
after calculating the similarity measure between the particular entity and each of the plurality of entities,
determining a maximum similarity measure from the calculated similarity measures; and
identifying one or more nearest neighbor entities from the plurality of entities, wherein a similarity measure between a nearest neighbor entity and the particular entity is determined to be within a threshold range of the maximum similarity measure.

23. The storage medium of claim 20, wherein comparing the compact vector v and a compact vector from a stored entity representation comprises:
computing the Hamming distance between the vectors by determining the number of corresponding b-bit groups between the vectors that have different values.

24. The storage medium of claim 20, wherein the locality-sensitive hashing is a MinHash.

25. The storage medium of claim 24, further comprising:
using the Hamming similarity between the compact vector v and the compact vector from a stored entity representation to approximate the Jaccard similarity between the feature vector representing the particular entity and the feature vector representing the entity represented by the stored entity representation.

26. The storage medium of claim 20, further comprising:
choosing an optimal value of b based in part on satisfying a memory budget.

27. A system comprising:
one or more computers and one or more storage devices storing instructions that are operable, when executed by the one or more computers, to cause the one or more computers to perform operations comprising:
receiving a hash vector r, a vector of locality-sensitive hash values, each hash value being an element of the hash vector r, each element having an index position; and
generating a compact vector v corresponding to the hash vector r, wherein the compact vector v is a vector of compact elements each having an index position, wherein each compact element corresponds to the element of the hash vector r having the same index position, and wherein each compact element is a b-bit integer selected from the set of all b-bit integers {0, 1, . . . , 2^{b}−1} based on the corresponding hash element.

28. The system of claim 27, wherein the hash vector r represents a feature vector that represents an entity, the system further comprising:
storing the compact vector v as a representation of the entity.

29. The system of claim 27, wherein each b-bit integer is uniformly selected from {0, 1, . . . , 2^{b}−1} based on the corresponding hash element and the index position of the hash element in the hash vector r.

30. The system of claim 27, wherein selecting the b-bit integer from the set of all b-bit integers comprises:
using a pseudorandom number generator that is initialized using the corresponding hash element as a seed.

31. The system of claim 27, wherein selecting the b-bit integer from the set of all b-bit integers comprises:
using a pseudorandom number generator that is initialized using the corresponding hash element and the index position of the corresponding hash element in hash vector r as a seed.

32. The system of claim 27, wherein generating the compact vector v comprises:
assigning each of the hash elements of hash vector r to one of 2^{b} groups, where each group has a unique b-bit integer identifier; and
for each compact element of the compact vector v,
identifying the group to which the corresponding hash element is assigned; and
assigning the b-bit identifier of the group to the index position of the compact element.

33. A system comprising:
one or more computers and one or more storage devices storing instructions that are operable, when executed by the one or more computers, to cause the one or more computers to perform operations comprising:
maintaining a data store of entity representations of a plurality of entities, each stored entity representation including a compact vector of N compact elements, wherein each compact element corresponds to an element of a hash vector of N hash elements generated using locality-sensitive hashing from a feature vector representing an entity, and wherein each compact element is a b-bit integer selected from the set of all b-bit integers {0, 1, . . . , 2^{b}−1} based on the corresponding hash element;
receiving a query including data representing a particular entity, the data including a compact vector v of N compact elements, wherein each compact element corresponds to an element of a hash vector of N hash elements generated using the locality-sensitive hashing from a feature vector representing the particular entity, and wherein each compact element is a b-bit integer selected from {0, 1, . . . , 2^{b}−1} based on the corresponding hash element; and
responsive to the query,
calculating a similarity measure between the particular entity and each of the plurality of entities by comparing the compact vector v and the compact vector included in the respective stored entity representation of the entity.

34. The system of claim 33, further comprising:
determining that an entity is similar to the particular entity if the similarity measure between the particular entity and the entity satisfies a similarity threshold.

35. The system of claim 33, further comprising:
after calculating the similarity measure between the particular entity and each of the plurality of entities,
determining a maximum similarity measure from the calculated similarity measures; and
identifying one or more nearest neighbor entities from the plurality of entities, wherein a similarity measure between a nearest neighbor entity and the particular entity is determined to be within a threshold range of the maximum similarity measure.

36. The system of claim 33, wherein comparing the compact vector v and a compact vector from a stored entity representation comprises:
computing the Hamming distance between the vectors by determining the number of corresponding b-bit groups between the vectors that have different values.

37. The system of claim 33, wherein the locality-sensitive hashing is a MinHash.

38. The system of claim 37, further comprising:
using the Hamming similarity between the compact vector v and the compact vector from a stored entity representation to approximate the Jaccard similarity between the feature vector representing the particular entity and the feature vector representing the entity represented by the stored entity representation.

39. The system of claim 33, further comprising:
choosing an optimal value of b based in part on satisfying a memory budget.
